(19) United States
(12) Patent Application Publication
(10) Pub. No.: US 2016/0297928 A1
(43) Pub. Date: Oct. 13, 2016

(54) Use Of Poly(Oxyalkylene)Oxy- And/Or Poly(Oxyalkylene)Aminoalkyltrialkoxysilanes As Dispersants

(71) Applicant: BASF SE, Ludwigshafen (DE)

(72) Inventors: Martin Ernst, Heidelberg (DE); Achim Feßenbecker, Waghäusel (DE)

(21) Appl. No.: 15/026,373

(22) PCT Filed: Sep. 30, 2014
(86) PCT No.: PCT/EP2014/070912

§ 371 Date: Mar. 31, 2016

(30) Foreign Application Priority Data
Oct. 2, 2013 (EP) 13187182.4

(51) Int. Cl. C08G 65/336; C04B 28/04; C04B 24/42

(52) U.S. Cl. CPC C08G 65/336; C04B 24/42; C04B 28/04

(57) ABSTRACT

Poly(oxyalkylene)oxy- and/or poly(oxyalkylene)aminoalkyltrialkoxysilanes are of the general formula (I)

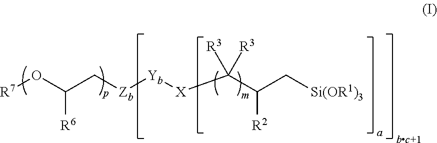

where
—X— is —O— or —N(R⁴)₂₋ₐ—;
—Y— is —CH₂—;
—Z— is —O—(CH₂)_{d}—C(R⁵)_{2-c}—;
a is 1 if —X—═—O—, and is 1 or 2 if —X—═—N(R⁴)₂₋ₐ—;
b is 0 or 1;
c is 0, 1 or 2;
d is 0 or 1;
m is independently from an integer from 1 to 6;
p is a number from 7 to 200;
R¹ is independently methyl, ethyl, n-propyl, isopropyl, n-butyl, isobutyl, sec-butyl, tert-butyl, or phenyl;
R² is H or methyl;
R³, R⁴, and R⁵ are independently H or linear or branched C₁-C₆-alkyl;
R⁶ is independently H, methyl or ethyl; and
R⁷ is H, linear or branched C₁-C₆-alkyl, linear or branched C₁-C₁₀-alkanoyl, or C₆-C₁₀-aryloyl;
   as dispersants for aqueous suspensions composed of aggregates and hydraulic binders, and to aqueous suspensions. Also provided: a process for preparing the alkyltrialkoxysilanes.

The present invention relates to the use of poly(oxyalkylene)oxy- and/or poly(oxyalkylene)aminoalkyltrialkoxysilanes as dispersants for aqueous suspensions composed of aggregates and hydraulic binders, and also to the aqueous suspensions as such. The invention also relates to a process for preparing the alkyltrialkoxysilanes, and to the alkyltrialkoxysilanes as such.

Aqueous suspensions composed of an aggregate and a hydraulic binder are frequently admixed with auxiliaries in the form of dispersants in order to influence their chemical and/or physical properties. A particular purpose this serves is to prevent the formation of agglomerated solids, and also to disperse the particles already present and those newly formed by hydration, in order thereby to suppress the sedimentation propensity and to improve the processing qualities, such as kneadability, spreadability, sprayability, pumpability or flowability. This effect is also deliberately exploited in the production of building material mixtures which comprise hydraulic binders such as cement, render binders and masonry binders, or hydraulic lime.

In order to convert these building material mixtures comprising hydraulic binders into a ready-to-use, processable form, the quantity of mixing water required is usually substantially more than would be necessary for the subsequent process of hydration or hardening. An example of a possible result of the excess water, which later evaporates, is the formation of void fractions in the concrete structure, leading to significantly impaired mechanical strength and durability.

In order to reduce the excess water fraction for a specified working consistency and/or in order to improve the workability for a specified ratio of water to hydraulic binder, auxiliaries are used which are generally referred to as water reducers or plasticizers. Examples of plasticizers conventionally used are sulfonated melamine-formaldehyde condensates (SMF), sulfonated naphthalene-formaldehyde condensates (SNF), or lignosulfonates.

Polycarboxylate esters and polycarboxylate ethers are considered to be new-generation plasticizers. They consist in general of a main chain, based on poly(meth)acrylate, and of a plurality of sidechains, attached via ester groups, and are frequently referred to as comb polymers. While the main chain carries a negative charge at alkaline pH levels, owing to the numerous carboxylate groups, the sidechains, such as polyethylene glycol sidechains, for example, commonly possess no charge. Because of the negatively charged main chain, the polycarboxylates are adsorbed on charged particle surfaces. The amount of polymer adsorbed as a result of the negative charge, and the nature of the polymer sidechain, determine the density and the thickness of the adsorbed polymer layer, which in turn influences the flowability of the polymer-enhanced suspension. While the anionic charge of the polycarboxylates makes it possible for the polymer actually to become adsorbed onto the particles, the dispersing effect is brought about decisively by a steric effect on the part of the polyoxyethylene sidechains. A part is played here both by the length and the density of the sidechains of the polycarboxylates.

EP 0 803 521 A1 discloses, for example, block copolymers comprising polyalkylene glycol and polyglyoxylate structural units, and the use thereof as cement dispersants.

In addition there are a range of other plasticizers, which differ from the polycarboxylate polymers described in that they do not possess any carboxylate groups. Instead, they have other acid groups, such as phosphonic acid groups, which are nevertheless likewise negatively charged at high pH levels, similarly to the carboxylate groups.

U.S. Pat. No. 5,879,445 A discloses compounds which comprise at least one phosphonic aminoalkylene group and at least one polyoxyalkylated chain, and also the use thereof as plasticizers for aqueous suspensions composed of mineral particles and hydraulic binders.

EP 444 542 discloses polyethylenimine phosphonate derivatives as plasticizers allowing the viscosity of well cement compositions to be reduced to an extent that they are pumpable under the conditions of turbulent flow even in the presence of salts.

EP 1203046 B1 describes dispersants with trialkoxysilane groups of the general formula

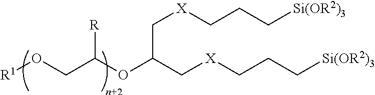

where
R is selected independently from H, methyl, ethyl, propyl, and styrene;
R¹ is selected from H, C₁-C₁₈-alkyl, phenyl, benzyl, and alkylsulfonate;
R² is selected from H and C₁-C₆-alkyl;
n is a number from 10 to 500; and
X is selected from

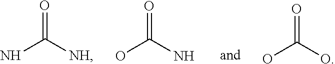

A disadvantage is the costly and inconvenient preparation of such dispersants, involving isocyanate reagents. Other possibilities for preparation are not disclosed.

Although good results are already being achieved in some cases with the plasticizers described, there is nevertheless a wide remaining space for improvements.

The plasticizers described do significantly improve the flow properties, but also give rise to side effects which in many cases are unwanted. One disadvantage, for example, lies in the sometimes significant retardation of setting that they cause. Consequently, they are of only limited usefulness, especially when a short setting time is desired for the hydraulic binder.

The problem addressed by the present invention is that of providing a dispersant which is especially suitable as a plasticizer/water reducer for aqueous suspensions composed of aggregates and hydraulic binders and which less severely retards the setting time of the hydraulic binder, by keeping the amount of phosphonate groups and/or carboxylate groups introduced at a low level.

It has been found that the use of poly(oxyalkylene)oxy- and/or poly(oxyalkylene)aminoalkyltrialkoxysilanes as dispersants for aqueous suspensions composed of aggregates and hydraulic binders reduces the viscosity of the aqueous suspension and causes less severe retardation of the setting time of the hydraulic binder.

The invention accordingly provides the use of a poly(oxyalkylene)oxy- and/or poly(oxyalkylene)aminoalkyltrialkoxysilane of the general formula (I) as dispersant for aqueous suspensions composed of an aggregate and a hydraulic binder,

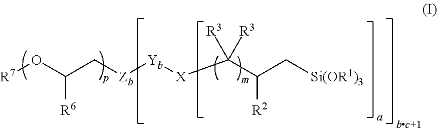

where the symbols and indices in the formula (I) have the following definitions:
—X— is —O— or -N(R⁴)₂₋ₐ—;
—Y— is —CH₂—;
—Z— is —O—(CH₂)_{d}—C(R⁵)_{2-c}—;
a is 1 if —X—═—O—, and is 1 or 2 if —X—═—N(R⁴)₂₋ₐ—;
b is 0 or 1;
c is 0, 1 or 2;
d is 0 or 1;
m is selected independently from an integer from 1 to 6;
p is a number from 7 to 200;
R¹ is identical or different and selected from the group consisting of methyl, ethyl, n-propyl, isopropyl, n-butyl, isobutyl, sec-butyl, tert-butyl, and phenyl;
R² is H or methyl;
R³, R⁴, and R⁵ are each identical or different and selected independently from the group consisting of H and linear or branched C₁-C₆-alkyl;
R⁶ is identical or different and selected independently from the group consisting of H, methyl and ethyl; and
R⁷ is selected from the group consisting of H, linear or branched C₁-C₆-alkyl, linear or branched C₁-C₁₀-alkanoyl, and C₆-C₁₀-aryloyl.

The alkyltrialkoxysilane of the general formula (I) has no anionic groups, as do the dispersants known from the prior art. It therefore presumably does not adsorb, owing to the charge, to charged surfaces of particulate solids. Instead, under the basic conditions prevailing in the aqueous suspension, the alkyltrialkoxysilane of the general formula (I) presumably binds covalently to silicate phases of particles of the hydraulic binder. It is presumed that the trialkoxysilane group here acts as an anchor, to fix the polyoxyalkylene chain to the particle surface of the aggregate that is to be dispersed. The dispersing effect here is brought about by the steric effect of the polyoxyalkylene chain, and positively influences the flowability of the aqueous suspension.

By virtue of the fact that the alkyltrialkoxysilane of the general formula (I) is charge-neutral and this neutrality is likely also retained after a presumed basic hydrolysis and a possible subsequent formation of covalent bonding to silicate phases of particles that are to be dispersed, the setting time of the hydraulic binder is influenced to much less of an extent than is the case with the usually multiply negatively charged plasticizers from the prior art.

In one embodiment of the present invention, the alkyltrialkoxysilane of the general formula (I) possesses only one first molecular segment (molecular segment C), consisting of a polyoxyalkylene group, this segment being bonded via a heteroatom X to one or two second molecular segment(s) (molecular segment(s) A), consisting of an alkylene spacer and a trialkoxysilane group. In the general formula (I), in this embodiment, b=0, and the alkyltrialkoxysilane has the formula (Ia)

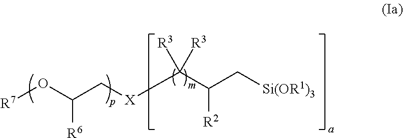

in which X, a, m, p, R¹, R², R³, R⁶, and R⁷ have the definition specified above.

In a preferred embodiment of the present invention, the alkyltrialkoxysilane of the general formula (I) consists of a molecular segment C, which is attached via an oxygen atom to a second molecular segment (A). In this preferred embodiment, therefore, in formula (Ia) above, —X—═—O— and a=1.

In a further-preferred embodiment, the alkyltrialkoxysilane of the general formula (I) possesses one or two molecular segment(s) A, which are bonded via a nitrogen atom to the molecular segment C. In this preferred embodiment, in formula (Ia) above, —X—═—N(R⁴)₂₋ₐ—, and a=1 or 2, with R⁴ having the definition designated above.

In another embodiment of the present invention, the alkyltrialkoxysilane of the general formula (I), as well as the molecular segments A and C, includes a further molecular segment B, which allows the number of trialkoxysilane groups to be increased. This is achieved by using a tertiary or quaternary carbon atom having a plurality of oxymethylene substituents. In this embodiment, in the general formula (I), b=1, —X—═—O—, a=1, and d=1, and the alkyltrialkoxysilane has the general formula (Ib),

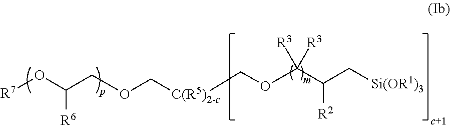

in which c, m, p, R¹, R², R³, R⁵, R⁶, and R⁷ have the definition specified above.

In one preferred embodiment, the alkyltrialkoxysilane of the general formula (I) possesses three molecular segments C, which are bonded via the molecular segment B, —O—CH₂—C(R⁵)_{2-c}—, to the molecular segment A. In this preferred embodiment, in formula (Ib) above, c=2. The alkyltrialkoxysilane in this embodiment has the following formula (Ic)

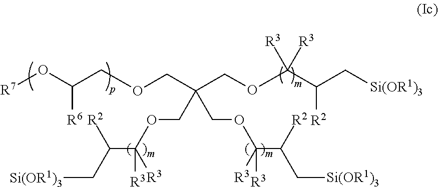

in which m, p, R¹, R², R³, R⁵, R⁶, and R⁷ have the definition specified above.

In a further-preferred embodiment, the alkyltrialkoxysilane of the general formula (I) possesses two molecular segments C, which are bonded via the molecular segment B, —O—CH₂—C(R⁵)_{2-c}—, to the molecular segment A. In this preferred embodiment, in the formula above, c=1 and R⁵═H or ethyl. The alkyltrialkoxysilane in this embodiment has the formula (Id),

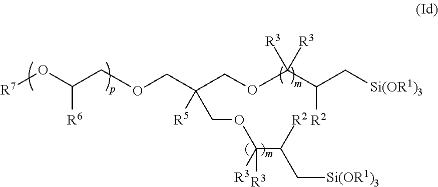

in which m, p, R¹, R², R³, R⁶, and R⁷ have the definition specified above.

In another embodiment of the present invention, the alkyltrialkoxysilane of the general formula (I) likewise contains the molecular segments A, B, and C. In this embodiment, in the general formula (I), b=1, —X—═—O—, a=1, and d=0, and the alkyltrialkoxysilane has the general formula (Ie),

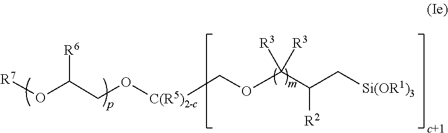

in which c, m, p, R¹, R², R³, R⁵, R⁶, and R⁷ have the definition specified above.

In a preferred embodiment, the alkyltrialkoxysilane of the general formula (I) possesses two molecular segments C, which are bonded via the molecular segment B, —O—C(R⁵)_{2-c}—, to the molecular segment A. In this preferred embodiment, in formula (Ie) above, c=1 and R⁵═H.

For the recited alkyltrialkoxysilanes of the general formulae (I), (Ia), (Ib), and (Ic), it is the case that p is preferably a number from 21 to 125.

Preferably R¹ is selected independently from methyl, ethyl, tert-butyl, and phenyl; more preferably R¹=ethyl.

Preferably R²═H.

Preferably R³═H.

Preferably m=1 or 2. More preferably m=1.

In one preferred embodiment, R³═H and m=1.

R⁶ is selected independently from H, methyl, and ethyl. In this case the individual radicals represented by R⁶, H, methyl, and ethyl, may be arranged either in statistical distribution on the polyethylene oxide chain consisting of p alkylene oxide units, or in the form of one or more blocks of radicals that are identical in each case. In the context of the present invention, a “block of radicals that are identical in each case” means a part of the polyethylene oxide chain that consists of at least two directly adjacent alkylene oxide units, in which the alkylene oxide units have identical radicals R⁶. The polyethylene oxide chain consisting of p alkylene oxide units preferably has a plurality of blocks of radicals that are identical in each case. More preferably R⁶ is selected independently from H and methyl. Very preferably R⁶═H.

Preferably R⁷ is H, methyl or acetyl. H and methyl are particularly preferred.

The terms “plasticizer” and “water reducer” refer for the purposes of the present invention to an admixture which leads to an improvement in the workability and/or a reduction in the water demand in the preparation of the aqueous suspension. The plasticizer is suitable in principle for three possible applications. One application pursues the objective of liquefying, or reducing the viscosity of; the aqueous suspension, for a specified ratio of water to hydraulic binder. In another application, the plasticizer is added in order to achieve a water saving for the aqueous suspension for a given consistency—and hence consistently good workability. As a result it is possible to reduce the ratio of water to hydraulic binder. The third possible application is that of achieving both liquefaction and a water saving as a result of adding the plasticizer.

The alkyltrialkoxysilane of the general formula (I) can be added diluted or neat at different stages in the preparation of aqueous suspensions—specifically during the actual preparation of the binders, or not until the stage of the mixing of the binders with water and, optionally, further aggregates. It may therefore be added, for example, during the milling of cement before, together with, or after the addition of milling assistants, early-strength enhancers, other plasticizers, and water reducers, or on its own. It may likewise be sprayed onto components of, or finished, dry mortar mixtures. It then develops its effect at the time since the pulverulent mixtures and granules are contacted with water for application in the form of the aqueous suspension.

The alkyltrialkoxysilane of the general formula (I) is generally water-soluble or water-dispersible. The alkyltrialkoxysilanes may be liquid or solid; they frequently possess a waxy consistency. It is advantageous to provide the alkyltrialkoxysilane of the general formula (I) in the form of an aqueous solution, in order to facilitate metering in the possible applications. This solution may include further additives such as air entrainers, defoamers, emulsifiers, and concrete admixtures. The alkyltrialkoxysilane of the general formula (I) may also be provided as a powder, including a powder which comprises a carrier such as silica or CaCO₃, for example, or in the form of flakes. Preference is given to providing the alkyltrialkoxysilane of the general formula (I) in the form of an aqueous solution or as a powder.

When the alkyltrialkoxysilane of the general formula (I) is used as a dispersant for aqueous suspensions composed of an aggregate and a hydraulic binder, the alkyltrialkoxysilane probably bonds covalently to silicate phases of particles of the hydraulic binder. Accordingly, the alkyltrialkoxysilane ought to bind, for example, to tricalcium silicate (alite) and/or dicalcium silicate (belite) phases of the clinker particles in the cement. Of course, however, it ought also to bind to silicate phases which are present in the selected aggregate. The alkyltrialkoxysilane of the general formula (I) is therefore particularly suitable for hydraulic binders which have an SiO₂ content of at least 2 wt %, based on the dry mass of the hydraulic binder. Hydraulic binders are binders which, after having been mixed with water, harden both in air and under water, and which, after having hardened, remain solid and dimensionally stable even under water.

The aqueous suspension is generally a building material mixture, preferably concrete or mortar.

Preferred hydraulic binders are cement, hydraulic lime, and geopolymeric silicate binder. With particular preference the hydraulic binder is selected from cement and geopolymeric silicate binder. With very particular preference the hydraulic binder is selected from Portland cement, Portland slag cement, Portland silica dust cement, Portland pozzolan cement, Portland flyash cement, Portland shale cement, Portland limestone cement, Portland composite cement, blast furnace cement, pozzolanic cement, composite cement, and mixtures thereof.

The term “aggregate” in the context of the present invention refers to all kinds of aggregates which may be included in hydraulic binders and have a suitable dimensional stability. The aggregates may come from natural deposits or may be obtained in the recycling of building materials or as industrial byproducts. Examples of suitable aggregates include uncrushed gravels and sand, gravelly material, chippings, crushed sands, rocks, blast furnace slag, fragmented clinker, recycled concrete chippings, pumice, lava sand, lava gravel, kieselguhr, expanded slate, expanded clay, pumice slag, heavy spar (barytes), magnetite, hematite, limonite and scrap.

It is optionally possible for admixtures to be present in the aqueous suspension. Admixtures in the sense of the present invention are liquid, pulverulent or granular substances which may be added to the suspension in small quantities, based on the dry mass of the hydraulic binder. They influence the properties of the suspension by chemical and/or physical effects. Suitable admixtures include setting accelerators, setting retarders, air entrainers, sealants, foam formers, defoamers, solidification accelerators, hardening accelerators, corrosion inhibitors, sedimentation reducers, other plasticizers and other water reducers than alkyltrialkoxysilane of the general formula (I), examples being polycarboxylate ethers, beta-naphthylsulfonic acid-formaldehyde condensates (BNS), lignosulfonate, sulfonated melamine-formaldehyde condensate, and mixtures thereof.

An optional possibility, furthermore, is for additives and fibers to be present in the aqueous suspension. “Additives” in the sense of the present invention are fine organic or inorganic substances which are used in order to obtain or specifically improve certain properties. They include virtually inert additives such as finely ground minerals or pigments, and also pozzolanic or latent hydraulic additives such as trass, flyash, silica dust, and finely ground slag sand. “Fibers” in the sense of the present invention are steel fibers, polymer fibers, and glass fibers in various sizes.

In one embodiment of the present invention, the aqueous suspension comprises an additive. The additive is preferably selected from glass fibers.

Added water for the aqueous suspension is suitably, for example, drinking water, ground water, and natural surface water (e.g., river water, lake water, spring water).

The amount of alkyltrialkoxysilane of the general formula (I) that is used is dependent on the requirements imposed on the aqueous suspension. Generally speaking, the alkyltrialkoxysilane is used in an amount of 0.005 to 5.0 wt %, based on the dry weight of the hydraulic binder, in the aqueous suspension. The alkyltrialkoxysilane of the general formula (I) is used preferably in an amount of 0.01 to 2.0 wt %, more preferably in an amount of 0.01 to 1.0 wt %, based on the dry weight of the hydraulic binder.

The alkyltrialkoxysilane of the general formula (I) may be effected before the other components are added, simultaneously with one or more other components, or after the other components have been added. The total amount of alkyltrialkoxysilane can be added all at once or in portions.

The amount of hydraulic binder used in the aqueous suspension, and the ratio of water to hydraulic binder, are critically dependent on the requirements imposed on the aqueous suspension and on the hardened solid that is formed from it. The same applies with respect to the nature of the aggregate to be used, the particle-size group to be used, and the relative quantity, especially the relative quantity with respect to the hydraulic binder. Moreover, the matter of whether and, if so, which auxiliaries, ancillary substances and/or fibers are added is critically dependent on the specific requirements. The nature and amount of these components to be used for a specific application are laid down exactly in numerous DIN EN standards, for example. For concrete and its individual components, for example, data are found in the following standards: DIN EN 206-1, DIN EN 197, DIN EN 12620, DIN EN 13139, DIN EN 13055-1, DIN EN 934-2, DIN EN 14889, DIN EN 1008. For mortar, the standard DIN EN 998-2, in particular, contains data on the nature and amount of the components to be used in each case for specific applications.

Generally speaking, the amount of hydraulic binder is between 100 and 600 kg/m³, the amount of aggregate is between 1000 and 3000 kg/m³, and the water content is between 50 and 600 kg/m³, based on one m³ of aqueous suspension. The ratio of water to hydraulic binder is typically 0.3 to 0.6.

The present invention further provides an aqueous suspension comprising as dispersant an alkyltrialkoxysilane of the general formula (I), as defined above, an aggregate, and a hydraulic binder.

The present invention also provides a process for preparing an alkyltrialkoxysilane of the general formula (I), as defined above, comprising the following steps:
(i) polyoxyalkylating a monomeric α,ω-alkenol and/or ω-alkenylamine of the general formula (II),

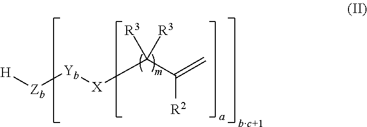

in which X, Y, Z, a, b, c, m, R², and R³ have the definition specified above,
with one or with two or more alkylene oxides selected from ethylene oxide, propylene oxide, and butylene oxide, under oxyalkylation conditions;
(ii) optionally alkylating or acylating the oxyalkylated alkenol and/or alkenylamine obtained in step (i), of the general formula (III),

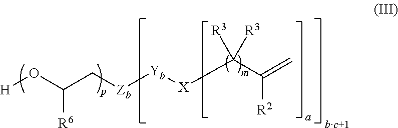

in which X, Y, Z, a, b, c, m, p, R², R³, and R⁶ have the definition specified above,
using an alkylating or acylating agent; and
(iii) hydrosilylating the unsaturated polyether obtained in step (ii), of the general formula (IV),

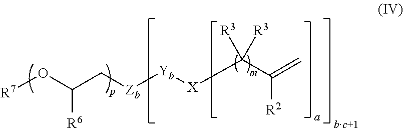

in which X, Y, Z, a, b, m, p, R², R³, R⁶, and R⁷ have the definition specified in any of claims 1 to 13,
with H—Si(OR¹)₃, in which R¹ has the definition specified above.

The present invention also provides an alkyltrialkoxysilane of the general formula (I), as defined above,

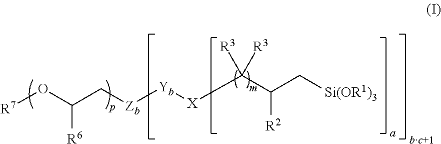

where the symbols and indices in the general formula (I) have the meaning defined above, and, for —X—═—O—, a=1, b=0, m=1, and R², R³, R⁶═H, the additional condition must be met that p is a number greater than 20.

The present invention is described in more detail, but not limited, by the following examples.

### EXAMPLES

### Example 1

### Synthesis of an Alkyltrialkoxysilane of the Invention

A 100 mL three-neck flask with N₂-blanketed reflux condenser and a magnetic stirrer bar was charged with 3.3 g of triethoxysilane (0.020 mol, M=167 g/mol). 3.0 g (0.021 mol, M=1160 g/mol) of an endgroup-capped allyl polyalkylene glycol ether (Breox CA 110 ME) were added, and the mixture was admixed with 0.6 mL of a solution of H₂PtCl₆.6H₂O (0.019 mmol, M=517) in acetone. The mixture was heated with stirring to 65° C. (oil bath temperature). Then, in portions, a further 21.7 g of Breox CA 110 ME were metered in over 20 minutes using a syringe. This was followed by stirring at 65° C. for 2 hours more, after which the temperature was raised to 90° C. During this time, acetone was driven off under a stream of nitrogen. Residual acetone and silane were removed under a reduced pressure of about 100 mbar at 65° C. The product was analyzed by ¹H NMR (CDCl₃). On the basis of the ratios of integrals of the signals of starting product (double bonding) and the sum total of reactant and product (methylene group), a conversion of 62% was computed.

### Example 2

### Slump Test of Substance from Example 1 in Standard Mortar

A mortar was prepared in accordance with DIN EN 196-1 from 450 g of Heidelberger Zement CEM I, 42.5 R cement, 1350 g of standard sand, and 225 g (minus the water to be added with the plasticizer). The plasticizer was added together with 7 wt % of Degressal®SD 40 defoamer from BASF SE, based on the dry mass of the plasticizer, after 90 seconds, during preparation of the mortar. The addition was followed by mixing for 60 seconds. The mortar was then introduced into a conical metal mold, which was placed on a jolting table with scale; excess mortar was stripped off at the top edge, and the mold was lifted up, leaving a conical cake of mortar on the slump table. After 6 strikes, the diameter of the cake was determined at 90° spacing. The measurement was repeated with the same mortar directly after preparation and after 30, 60, 90, 120 and 150 minutes. Prior to each further measurement, stirring was carried out manually once by means of a spoon. The temperature was 23+/−1° C.

| | Plasticizer | | | | | | |
|---|---|---|---|---|---|---|---|
| | Metering | Slump | Slump | Slump | Slump | Slump | Slump |
| | [% based | after | after | after | after | after | after |
| | on | 1 min | 30 min | 60 min | 90 min | 120 min | 150 min |
| | cement] | [cm] | [cm] | [cm] | [cm] | [cm] | [cm] |
| Example 1 | 0.185 | 19.50 | 17.6 | 16.05 | 16.35 | 15.15 | 13.3 |
| | 0.390 | 19.75 | 18.2 | 17.35 | 16.45 | 16.25 | 15.35 |
| Comparative | — | 19.15 | 14.85 | not | not | not | not |
| example | | | | determinable | determinable | determinable | determinable |
| without | | | | | | | |
| addition | | | | | | | |

A clear relationship can be seen between the plasticizing effect and the metering quantity, especially in the case of long experiment times. Relative to the blank sample, a significantly improved slump effect is achieved even for a low metering quantity. The plasticizer of the invention therefore increases the time within which mortar or concrete can be worked (pumped, incorporated, divided).

1. A poly(oxyalkylene)oxy- and/or poly(oxyalkylene)aminoalkyltrialkoxysilane of the general formula (I) as dispersant for aqueous suspensions composed of an aggregate and a hydraulic binder, 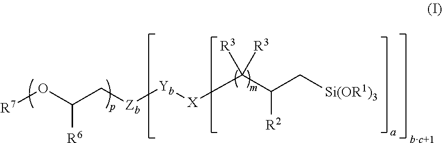
where the symbols and indices in the formula (I) have the following definitions:
—X— is —O— or —N(R⁴)₂₋ₐ—;
—Y— is —CH₂—;
—Z— is —O—(CH₂)_{d}—C(R⁵)_{2-c}—;
a is 1 if —X—═—O—, and is 1 or 2 if —X—═—N(R⁴)₂₋ₐ—;
b is 0 or 1;
c is 0, 1 or 2;
d is 0 or 1;
m is selected independently from an integer from 1 to 6;
p is a number from 7 to 200;
R¹ is identical or different and selected from the group consisting of methyl, ethyl, n-propyl, isopropyl, n-butyl, isobutyl, sec-butyl, tert-butyl, and phenyl;
R²is H or methyl;
R³, R⁴, and R⁵ are each identical or different and selected independently from the group consisting of H and linear or branched C₁-C₆-alkyl;
R⁶is identical or different and selected independently from the group consisting of H, methyl and ethyl; and
R⁷is selected from the group consisting of H, linear or branched C₁-C₆-alkyl, linear or branched C₁-C₁₀-alkanoyl, and C₆-C₁₀-aryloyl.

2. The poly(oxyalkylene)oxy- or poly(oxyalkylene)aminoalkyltrialkoxysilane according to claim 1, wherein b=0 and the alkyltrialkoxysilane has the general formula (Ia) 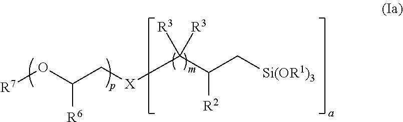
in which X, a, m, p, R¹, R², R³, R⁶, and R⁷ have the definition specified in claim 1.

3. The poly(oxyalkylene)oxy- or poly(oxyalkylene)aminoalkyltrialkoxysilane according to claim 2, wherein —X—═—O— and a=1.

4. The poly(oxyalkylene)oxy- or poly(oxyalkylene)aminoalkyltrialkoxysilane according to claim 2, wherein —X—═—N(R⁴)₂₋ₐ—, and a=1 or 2.

5. The poly(oxyalkylene)oxy- or poly(oxyalkylene)aminoalkyltrialkoxysilane according to claim 1, wherein b=1, —X—═—O—, a=1, and d=1, and the alkyltrialkoxysilane has the general formula (Ib), 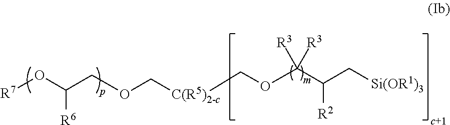
in which c, m, p, R¹, R², R³, R⁵, R⁶, and R⁷ have the definition specified in claim 1.

6. The poly(oxyalkylene)oxy- or poly(oxyalkylene)aminoalkyltrialkoxysilane according to claim 5, wherein c=2.

7. The poly(oxyalkylene)oxy- or poly(oxyalkylene)aminoalkyltrialkoxysilane according to claim 5, wherein c=1, and R⁵═H or ethyl.

8. The poly(oxyalkylene)oxy- or poly(oxyalkylene)aminoalkyltrialkoxysilane according to claim 1, wherein p is a number from 21 to 125.

9. The poly(oxyalkylene)oxy- or poly(oxyalkylene)aminoalkyltrialkoxysilane according to claim 1, wherein R¹=ethyl.

10. The poly(oxyalkylene)oxy- or poly(oxyalkylene)aminoalkyltrialkoxysilane according to claim 1, wherein R²═H.

11. The poly(oxyalkylene)oxy- or poly(oxyalkylene)aminoalkyltrialkoxysilane according to claim 1, wherein R³═H and m=1.

12. The poly(oxyalkylene)oxy- or poly(oxyalkylene)aminoalkyltrialkoxysilane according to claim 1, wherein R⁶═H.

13. The poly(oxyalkylene)oxy- or poly(oxyalkylene)aminoalkyltrialkoxysilane according to claim 1, wherein R⁷ is selected from H, methyl, and acetyl.

14.-15. (canceled)

16. An aqueous suspension comprising as dispersant an alkyltrialkoxysilane as defined in claim 1, an aggregate, and a hydraulic binder.

17. A process for preparing an alkyltrialkoxysilane of the general formula (I) as defined in claim 1, comprising the steps of:
(i) polyoxyalkylating a monomeric α,ω-alkenol and/or ω-alkenylamine of the general formula (II), 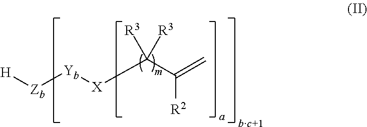
in which X, Y, Z, a, b, c, m, R², and R³ have the definition specified in claim 1,
with one or with two or more alkylene oxides selected from ethylene oxide, propylene oxide, and butylene oxide, under oxyalkylation conditions;
(ii) optionally alkylating or acylating the oxyalkylated alkenol and/or alkenylamine obtained in step (i), of the general formula (III), 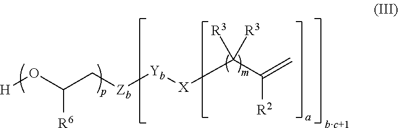
in which X, Y, Z, a, b, c, m, p, R², R³, and R⁶ have the definition specified in any of claims 1 to 13,
using an alkylating or acylating agent; and
(iii) hydrosilylating the unsaturated polyether obtained in step (ii), of the general formula (IV), 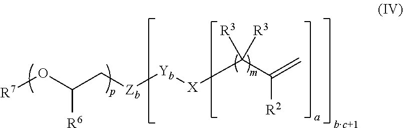
in which X, Y, Z, a, b, m, p, R², R³, R⁶, and R⁷ have the definition specified in claim 1,
with H—Si(OR¹)₃, in which R¹ has the definition specified in claim 1.

18. The poly(oxyalkylene)oxyalkyltrialkoxysilane or poly(oxyalkylene)aminoalkyltrialkoxysilane according to claim 1,
wherein for —X—═—O—, a=1, b=0, m=1, and R², R³, and R⁶═H, the additional condition is met that p is a number greater than 20.
